(19) United States
(12) Patent Application Publication
(10) Pub. No.: US 2004/0035939 A1
(43) Pub. Date: Feb. 26, 2004

(54) Multifunction memory card reading/writing device

(76) Inventor: Jin-Min Lin, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,514

(22) Filed: Aug. 21, 2002

(51) Int. Cl. G06K 19/00

(52) U.S. Cl. 235/487; 235/492

(57) ABSTRACT

A memory card reading/writing device includes a receptacle for directly receiving and accessing a first memory card and an adaptor defining a receiving space for receiving a second memory card that is different from the first memory card. The adaptor is receivable in the receptacle for electrically connecting the second memory card to the receptacle. A control circuit that is in electrical connection with the receptacle is connectable to a USB interface of for example a computer system for transfer of data between the memory cards and the computer systems. The control circuit includes first and second accessing devices for respectively and selectively accessing the first and second memory cards and a device for conversion of USB interfaced data transfer whereby data is transferred between the memory card and the USB host.

### BACKGROUND OF THE INVENTION

1. Field of the Invention

The present invention generally relates to an electronic memory reading/writing device, and in particular to an electronic memory reading/writing device for accessing two or more types of electronic memory card.

2. The Related Art

Electronic memory in the form of a card, such as Compact Flash (CF) card, Security Digital (SD) card, Multi-Media card (MMC), Smart Media card and Memory Stick, is widely used in a variety of electronic appliances for storage of data and application software. For example, a digital camera is commonly provided with an electronic memory for storage of pictures in digital form. Another well-known application of the memory card is to provide an additional memory to a notebook computer. The memory card can be selectively connected to the notebook computer for storage of data and information. To access the memory, the electronic device, such as the notebook computer, must be equipped with a memory card reading/writing device, which is either IDE based or USB based. Such a memory card reading/writing device is capable to access a particular kind of memory card that is compatible to the reading/writing device.

Since conventionally, each particular reading/writing device can access only the associated type of memory card, it causes problems to users in transferring data and imposes certain constraint to employ memory cards of different types. For example, to transfer data between different memory cards, a user must have different memory reading/writing devices associated with the memory cards used. This causes additional expenses to the general consumers. Furthermore, the user must learn to operate different memory reading/writing devices.

Individual connection devices for connecting different memory cards to a particular memory reading/writing device are also available. Such devices are provided with different control circuit for conversion of information between different types of memory cards and the memory reading/writing device. Such circuits add extra costs in manufacturing and maintenance. In addition, the overall size of the connection device is increased.

Combining reading/writing units for different types of memory cards together in a single housing, although allowing a user to access different memory cards with a single device, substantially increases the overall size and complicates the operation thereof. In addition, misplacing memory cards in incorrect reading/writing units may happen and result in damage of data.

Thus, it is desired to have an electronic memory card reading/writing device that does not have the above-discussed problems.

### SUMMARY OF THE INVENTION

An object of the present invention is to provide an electronic memory card reading/writing device capable to access (read and write) two or more types of memory cards.

Another object of the present invention is to provide an electronic memory card reading/writing device for reading/writing a first type of memory card and comprising an adaptor for connecting a different, second type of memory card to the electronic memory card reading/writing device for allowing the reading/writing device to access the second type of memory card.

A further object of the present invention is to provide an electronic memory card reading/writing device for directly and indirectly accessing first and second types of memory cards wherein a common control circuit is incorporated to handle the reading/writing operation to both the first and second memory cards.

Yet a further object of the present invention is to provide an adaptor for coupling an electronic memory card to an electronic memory reading/writing device and directly connecting the electronic memory card to the control circuit of the reading/writing device without any circuit being formed in the adaptor.

To achieve the above objects, in accordance with the present invention, there is provided a memory card reading/writing device comprising a receptacle for directly receiving and accessing a first memory card and an adaptor defining a receiving space for receiving a second memory card that is different from the first memory card. The adaptor is receivable in the receptacle for electrically connecting the second memory card to the receptacle. A control circuit that is in electrical connection with the receptacle is connectable to a USB interface of for example a computer system for transfer of data between the memory cards and the computer systems. The control circuit includes first and second accessing devices for respectively and selectively accessing the first and second memory cards and a device for conversion of USB interfaced data transfer whereby data is transferred between the memory card and USB bus.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view showing a receptacle of an electronic memory card reading/writing device in accordance with the present invention and a first type of memory card to be inserted into the receptacle;

FIG. 2 is a perspective view similar to FIG. 1 showing a second type of memory card is coupled to the receptacle by means of an adaptor in accordance with the present invention;

FIG. 3 is a perspective view similar to FIG. 2 showing a third type of memory card is coupled to the receptacle by means of an adaptor in accordance another embodiment of the present invention;

FIG. 4 is a perspective view similar to FIG. 2 showing a fourth type of memory card is coupled to the receptacle by means of an adaptor in accordance with a further embodiment of the present invention;

FIG. 5 is a block diagram of a control circuit of the electronic memory card reading/writing device in accordance with the present invention;

FIG. 6 is a block diagram of a modified control circuit in accordance with the present invention; and

FIG. 7 is a schematic view showing the electronic memory card reading/writing device of the present invention incorporated in a computer system.

### DETAILED DESCRIPTION OF THE PREFERRED EMBODIMENT

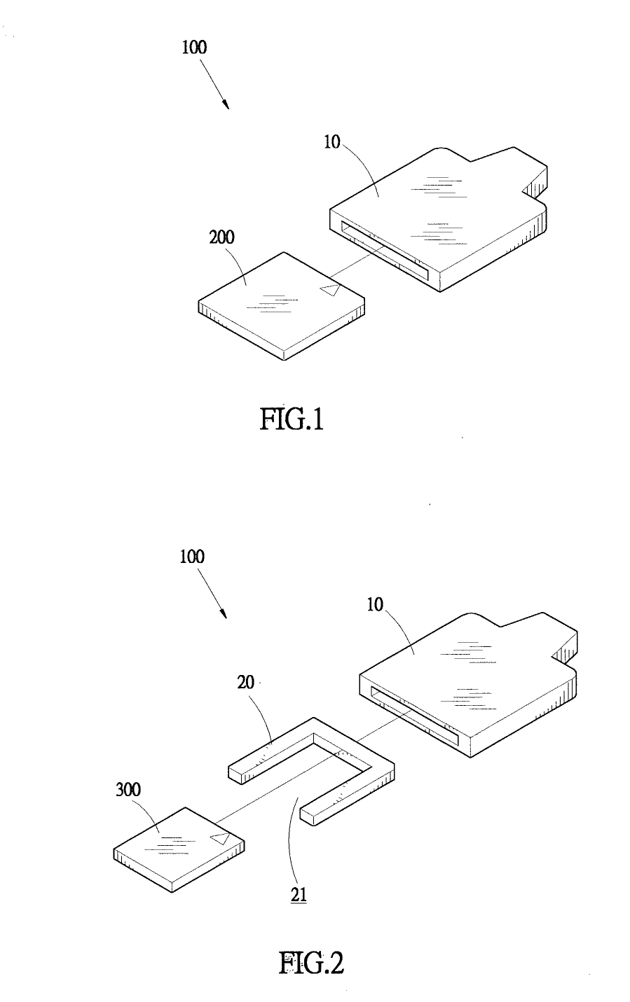

With reference to the drawings and in particular to FIGS. 1 and 2, an electronic memory card reading/writing device constructed in accordance with the present invention, generally designated with reference numeral 100, comprises a receptacle 10 and an adaptor 20. The receptacle 10 is sized and configured to directly receive a first type of memory card 200 therein for access of the memory card 200. The adaptor 20 is sized and configured to be inserted into the receptacle 10 in the same way as the first memory card 200. The adaptor 20 defines a receiving space 21 sized and configured to receive a second type of memory card 300 therein for indirectly connecting the second memory card 300 to the receptacle 10 and allowing the receptacle 10 to access the second memory card 300. The first and second memory cards 200, 300 are of different specifications. For example, the first memory card 200 is a Compact Flash (CF) card while the second memory card 300 is a Smart Media card.

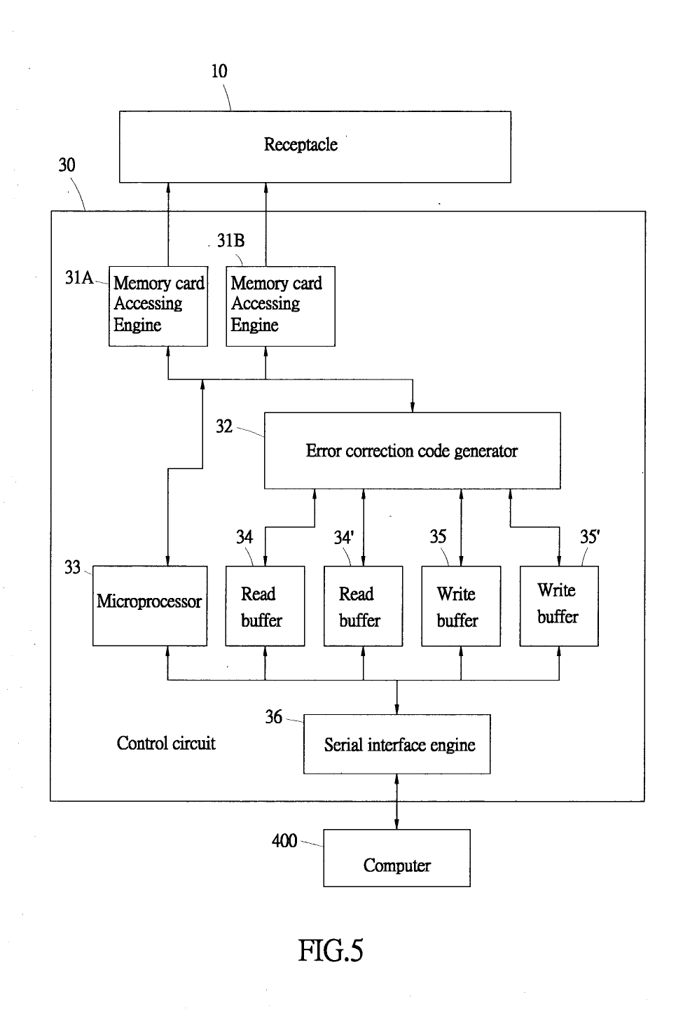

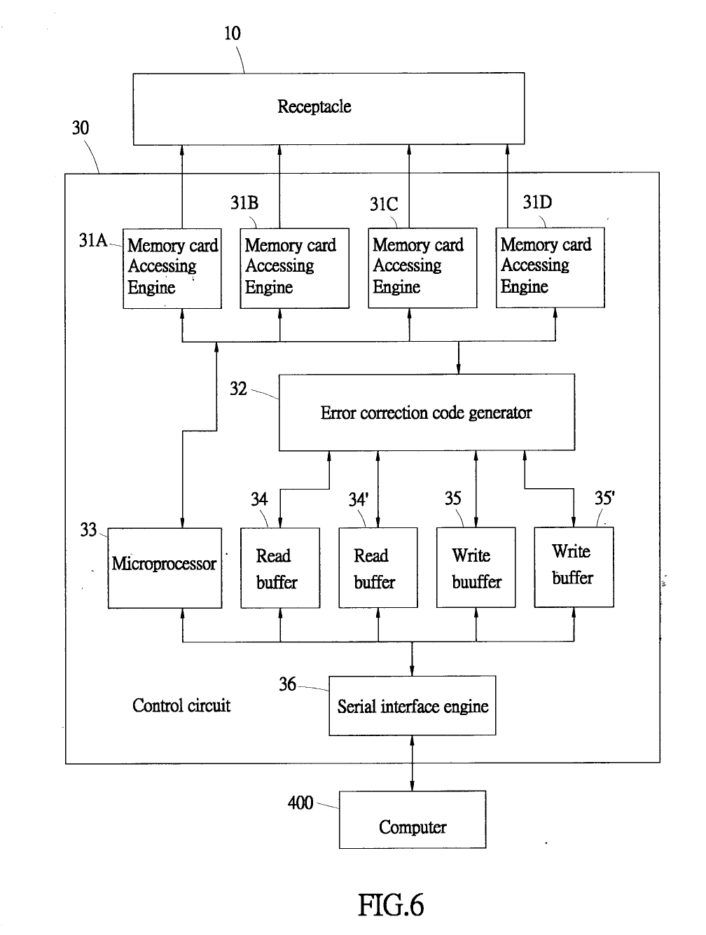

The reading/writing device 100 further comprises a control circuit 30 (FIGS. 5 and 6) that is electrically connected to the memory card 200, 300 when the memory card 200, 300 is received in the receptacle 10 directly or via the adaptor 20. The control circuit 30 performs reading and writing operation on the memory card 200, 300. A further discussion of the control circuit 30 will be given with reference to FIGS. 5 and 6.

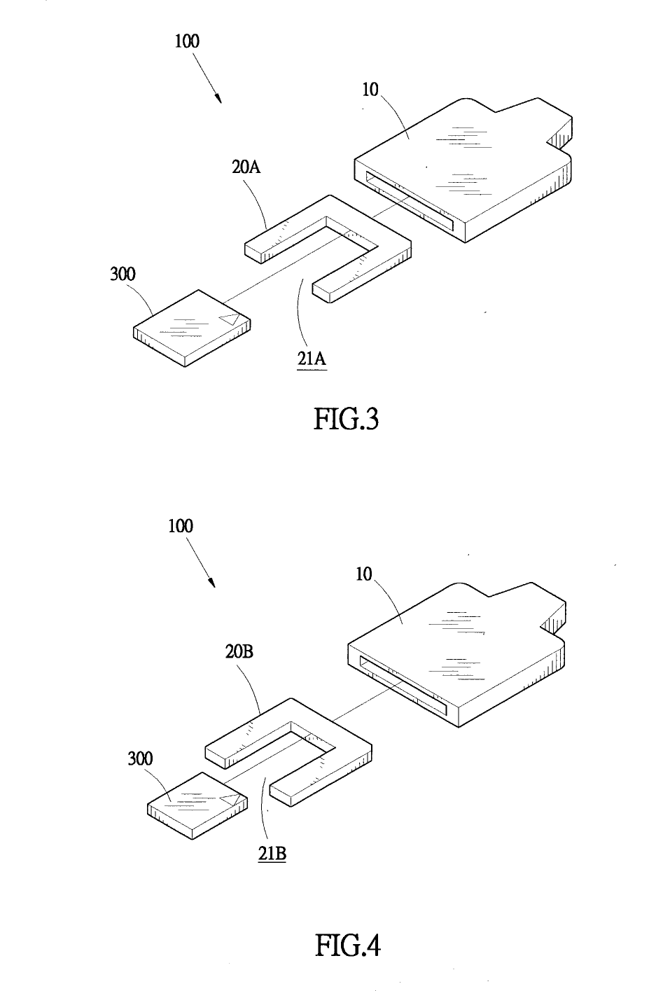

Referring to FIG. 3, the reading/writing device 100 may comprise an additional adaptor 20A, which is sized and configured to be receivable in the receptacle 10. The adaptor 20A defines a receiving space 21A for receiving and connecting a third type of memory card, which is also designated with, reference numeral 300 for simplicity. The third memory card is different from the first and second memory cards. For example, the third memory card is a SD (Security Digital)/MMC (Multi-Media Card) card.

Referring to FIG. 4, the reading/writing device 100 may comprise a further additional adaptor 20B, which is sized, and configured to be receivable in the receptacle 10. The adaptor 20B defines a receiving space 21B for receiving and connecting a fourth type of memory card, which is also designated with, reference numeral 300 for simplicity. The fourth memory card is different from the first, second and third memory cards. For example, the fourth memory card is a Memory Stick.

Also referring to FIG. 5, the control circuit 30 of the reading/writing device 100 in accordance with the present invention comprises first and second memory card accessing engines 31A, 31B, an error correction code generator 32, a microprocessor 33, two read buffers 34, 34′, two write buffers 35, 35′ and a serial interface engine 36. The first and second memory card accessing engines 31A, 31B are interfaces for reading and writing the first and second memory cards 200, 300 respectively. The number of the memory card accessing engines can be increased. For example and as shown in FIG. 6, four memory card accessing engines 31A, 31B, 31C and 31D are incorporated in the control circuit 30 for respectively accessing first, second, third and fourth memory cards 200, 300. As mentioned above, the first, second, third and fourth memory cards can be CF card, Smart Media Card, SD/MMC card and Memory Stick.

The memory card accessing engines 31A, 31B, 31C, 31D are connected to the receptacle 10 electrically and pins of the engines 31 A, 31B, 31C, 31D partially share the same definition whereby the engines 31A, 31B, 31C, 31D can properly access the first, second, third and fourth memory cards 200, 300 via the receptacle 10 and the adaptors 20, 20A, 20B. An example of the pin definition for all the memory cards 200, 300, including CF card, Smart Media Card, SD/MMC card and Memory Stick is shown in the following table.

| Pin | CF | Smart Media | SD/MMC | Memory Stick |
|---|---|---|---|---|
| P1 | CF_GND1 | SM_GND1 | SD_GND1 | MS_GND1 |
| | | SM_GND3 | | |
| P2 | CF_D03 | SM_D03 | SD_D03 | |
| P3 | CF_D04 | SM_D04 | | MS_SDIO |
| P4 | CF_D05 | SM_D05 | | |
| P5 | CF_D06 | SM_D06 | | |
| P6 | CF D07 | SM_D07 | SD_CD # | |
| P7 | CF CS0 # | SM_CE # | | MS_BS |
| P8 | CF_A10* | | | |
| P9 | CF_ATA_SEL # | | | |
| P10 | CF_A09* | | | |
| P11 | CF_A08* | | | |
| P12 | CF_A07* | | | |
| P13 | CF_VCC1 | SM_VCC1/ | SD_VCC | MS_VCC1 |
| | | SM_LVD | | |
| P14 | CF_A06* | | | |
| P15 | CF_A05* | | | |
| P16 | CF_A04* | | | |
| P17 | CF_A03* | | | |
| P18 | CF_A02 | SM_WP # | | |
| P19 | CF_A01 | SM_ALE | | |
| P20 | CF_A00 | SM_CLE | | |
| P21 | CF_D00 | SM_D00 | SD_D00 | |
| P22 | CF_D01 | SM_D01 | SD_D01 | |
| P23 | CF_D02 | SM_D02 | SD_D02 | |
| P24 | CF_IOCS16# | SM_CD # | | |
| P25 | CF_CD2# | | | |
| P26 | CF_CD1# | | | |
| P27 | CF_D11 | | | |
| P28 | CF_D12 | | | |
| P29 | CF_D13 | | | |
| P30 | CF_D14 | | | |
| P31 | CF_D15 | | | |
| P32 | CF_CS1# | | | |
| P33 | CF_VS1# | | | |
| P34 | CF_IORD # | SM_RE # | | |
| P35 | CF_IOWR # | SM_WE # | SD_CLK | MS_SCLK |
| P36 | CF_WE # | | | |
| P37 | CF_INTRQ | | | MS INS |
| P38 | CF_VCC2 | SM_VCC2 | | MS_VCC2 |
| P39 | CF_CSEL # | | | |
| P40 | CF_VS2# | | | |
| P41 | CF_RESET # | | | |
| P42 | CF_IORDY | SM_RB # | | |
| P43 | CF_INPACK # | | | |
| P44 | CF_REG # | | | |
| P45 | CF_DASP # | | | |
| P46 | CF_PDIAG # | | SD_CMD | |
| P47 | CF_D08 | SM_WPD2# | SD_WP1# | |
| P48 | CF_D09 | | | |
| P49 | CF_D10 | | | |
| P50 | CF_GND2 | SM_GND2/ | SD_GND2/ | MS_GND2 |
| | | SM_WPD1# | SD_WP2# | |

With the aid of the above table, the second, third and fourth memory cards 300 can be accessed by the memory card accessing engines 31B, 31C, 31D via the receptacle 10 and the associated adaptors 20A, 20B, 20C. The adaptors 20A, 20B, 20C are configured to form proper connection between the engines and the cards.

The error correction code generator 32 is coupled between the memory card accessing engines 31A, 31B, 31C, 31D and the write buffers 35, 35′ and read buffers 34, 34′. The error correction code generator 32, as the name suggests, generates error correction code (ECC) during reading and writing the memory cards 200, 300 by the memory card accessing engines 31A, 31B, 31C, 31D and check the ECC to the data read from the memory cards 200, 300 or add the ECC to the data written to the memory cards 200, 300.

The memory card accessing engines 31A, 31B, 31C, 31D are also connected to the microprocessor 33 whereby the microprocessor 33 detects the connection between the memory card accessing engines 31A, 31B, 31C, 31D with the associated memory cards 200, 300 when a memory card is received in the receptacle 10. Once the memory card is detected, the microprocessor 33 initializes the reading/writing operation of the particular type of memory card. The microprocessor 33 is capable to convert USB based storage class commands into control commands of each type of memory cards, including pin definition of the memory cards, in order to control the operation of the memory card accessing engines 31A, 31B, 31C, 31D. The microprocessor 33 also controls the serial interface engine 36 for connection with a host computer 400 or a storage medium for data transfer between the memory cards 200, 300 and the host computer or the storage medium.

The read buffers 34, 34′ and write buffers 35, 35′ are coupled between the error correction code generator 32 and the serial interface engine 36 for temporarily storing data that is read or written by the memory card accessing engines 31A, 31B, 31C, 31D in order to provide a data buffer for mass transfer of a great amount of data.

The serial interface engine 36 provides an interface between the control circuit 30 and a USB interface of the host computer 400 (or a USB host interface of a embedded system) to allow the data read from the memory cards 200, 300 to be transferred to the host computer 400 or the embedded system or to allow data from the computer 400 to be written into the control circuit 30 for transfer to the memory cards 200, 300.

The control circuit 30 can be of a number of varieties different from those shown in FIGS. 5 and 6 provided the above-discussed functions can be accomplished. In addition, the control circuit 30 can be embodied as an integrated circuit in a chip. This may significantly reduces the overall size of the reading/writing device 100 of the present invention.

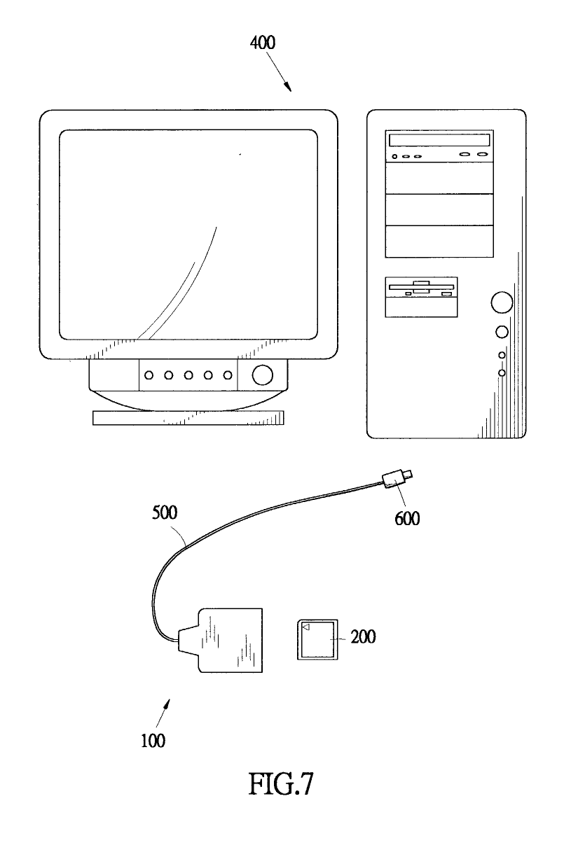

Also referring to FIG. 7, an application of the reading/writing device 100 of the present invention will be discussed. The reading/writing device 100 is coupled to a computer 400 by means of a USB cable 500 and a USB plug 600 which are connected to the receptacle 10 of the reading/writing device 100. The USB plug 600 can connect to a USB port of the computer 400.

The second memory card 300, namely the Smart Media card, is taken as an example to describe the operation of the reading/writing device 100 of the present invention. When the second memory card 300 is received in the receptacle 10 by means of the adaptor 20, the pins of the second memory card 300 are electrically connected to the associated pins of the memory card accessing engine 31B. The microprocessor 33 detects and identifies the second memory card 300 and initializes the associated reading/writing operation of the second memory card 300. If available, the microprocessor 33 takes commands from the computer 400 via the serial interface engine 36 for controlling the reading and writing operation of the memory card accessing engine 31B.

In a reading operation, data is transferred from the memory card 300 to the computer 400. The data from the memory card 300 is transferred, in sequence, through the memory card accessing engine 31B, the error correction code generator 32, the read buffers 34, 34′ and the serial interface engine 36 and eventually reaches the computer 400. The read buffers 34, 34′ operate in pair wherein while a first batch of data is uploaded into the computer 400 from the first buffer 34, a second batch of data is transferred from the memory card 300 to the second buffer 34′ and while the uploading of the first batch of data is completed, the second batch of data is uploaded to the computer 400 and at this moment, a third batch of data is transferred from the memory card 300 to the first buffer 34. The roles of the first and second buffers 34, 34′ are repeatedly interchanged.

In a writing operation, data is transferred from the computer 400 to the memory card 300. The data from the computer 400 is transferred, in sequence, through the serial interface engine 36, the write buffers 35, 35′, the error correction code generator 32 and the memory card accessing engine 31B, and eventually reaches the memory card 300. The write buffers 35, 35′ operate in the same way as the read buffers 34, 34′ and no further description is needed.

Other types of memory cards, such as the first, the third and the fourth memory cards 200, 300 can be handled in substantially the same way as the second memory card described above. No further detail is needed.

The reading/writing device 100 of the present invention has the following advantages:

(1) Different memory cards can be accessed by a single receptacle provided in the reading/writing device 100 with the aid of adaptors. No mistaken insertion of a memory card into incorrect receptacle can be made.

(2) Access of different memory cards can be done with a single control circuit. The configuration and structure of the reading/writing device is simplified and can be made portable in view of the reduced size resulting from the simplified structure.

(3) No sophisticated circuit and electronic devices are required inside the adaptors whereby costs can be reduced and the structure be simplified. This enhances mass production of the reading/writing device.

Although the present invention has been described with reference to the preferred embodiment thereof, it is apparent to those skilled in the art that a variety of modifications and changes may be made without departing from the scope of the present invention which is intended to be defined by the appended claims.

What is claimed is

1. A memory card reading/writing device comprising:
a receptacle for directly receiving and accessing a first memory card;
an adaptor defining a receiving space for receiving a second memory card that is different from the first memory card, the adaptor being mechanically receivable in the receptacle for electrically connecting the second memory card to the receptacle; and
a control circuit in electrical connection with the receptacle and being adapted to connect to a USB interface of an USB host controller, the control circuit comprising first and second accessing devices for respectively and selectively accessing the first and second memory cards and a device for conversion of USB interfaced data transfer whereby data is transferred between the memory card and the USB host controller.

2. The memory card reading/writing device as claimed in claim 1, wherein the first memory card is a compact flash card.

3. The memory card reading/writing device as claimed in claim 1, wherein the second memory card is a smart media card.

4. The memory card reading/writing device as claimed in claim 1, wherein the second memory card is a SD/MMC card.

5. The memory card reading/writing device as claimed in claim 1, wherein the second memory card is a memory stick.

6. The memory card reading/writing device as claimed in claim 1, wherein the control circuit further comprises third and fourth accessing devices for accessing a third memory card and a fourth memory card, two additional adaptors being selectively receivable in the receptacle for selectively connecting the third and fourth memory cards to the control circuit.

7. The memory card reading/writing device as claimed in claim 6, wherein the first memory card is a compact flash card, the second memory card is a smart media card, the third memory card is a SD/MMC card and the fourth memory card is a memory stick.

8. The memory card reading/writing device as claimed in claim 1, wherein the control circuit further comprises:
first and second memory card accessing engines respectively connected to the receptacle and corresponding to the first and second memory cards to respectively access the first and second memory cards;
a microprocessor connected to the first and second memory card accessing engines for detection of the first and second memory cards, converting USB based storage class commands into control commands for the first and second memory cards and initializing and controlling reading and writing operation of the memory cards;
an error correction code generator connected to the first and second memory card accessing engines for generating and adding error correction codes to data read from and written into the memory cards;
a serial interface engine adapted to connect to the USB host for transferring commands from the USB host to the microprocessor for performing reading and writing operation on the first and second memory cards and transferring data from the first and second memory cards in USB based form to the USB host or from the USB host to the first and second memory cards; and
read buffers and write buffers connected between the error correction code generator and the serial interface engine to provide buffers for data read from and written to the memory cards.
